(19) United States
(12) Patent Application Publication
(10) Pub. No.: US 2018/0267971 A1
(43) Pub. Date: Sep. 20, 2018

(54) MULTIMEDIA PLAYING METHOD AND SYSTEM FOR MOVING VEHICLE

(71) Applicant: Acer Incorporated, New Taipei City (TW)

(72) Inventor: I-Chun Chou, New Taipei City (TW)

(73) Assignee: Acer Incorporated, New Taipei City (TW)

(21) Appl. No.: 15/821,855

(22) Filed: Nov. 24, 2017

(30) Foreign Application Priority Data
Mar. 15, 2017 (TW) 106108468

(51) Int. Cl. G06F 17/30

(52) U.S. Cl. CPC G06F 17/30041; G06F 17/3005; G06F 17/3002

(57) ABSTRACT

A multimedia playing method and a multimedia playing system for moving vehicle are provided. The method includes following steps. At least one multimedia content is stored in a multimedia database. A search condition is obtained according to environmental information nearby the moving vehicle. The multimedia database is queried according to the search condition to retrieve at least one target multimedia content matching to the search condition. The target multimedia content is played by a multimedia playing device on the moving vehicle.

### CROSS-REFERENCE TO RELATED APPLICATION

This application claims the priority benefit of Taiwan application serial no. 106108468, filed on Mar. 15, 2017. The entirety of the above-mentioned patent application is hereby incorporated by reference herein and made a part of this specification.

### BACKGROUND OF THE INVENTION

### Field of the Invention

The invention relates to a multimedia playing method, and particularly relates to a multimedia playing method and system for moving vehicle.

### Description of Related Art

Along with development of technology, various image capturing devices such as cameras, video cameras, etc., have played an indispensable role in people's daily life, and daily life or working environment is regarded as a stage where the image capturing device plays its role. A user may record beautiful images to keep as a souvenir at anytime anyplace by using a product having a camera function. Therefore, acquisition and preservation of digital photos become more and more convenient and easy.

However, since most of the digital photos are stored in a storage medium of an electronic apparatus, and are not presented in physical photo papers or album, the user is often lack of motivation to take out the photos fully of memories to view one-by-one. For example, the user generally takes a large amount of photos by using the product having the camera function in case of travelling, though after the travelling, the user generally no longer opens these photo files after viewing the photos for once or twice. Even more, since the number of the photos is too large, existence of some photos is also easy to be forgotten. Therefore, an existence value of the photos is gradually confined to record facts and sceneries, and a function of these photos for reminding people with precious memories cannot be reflected.

### SUMMARY OF THE INVENTION

The invention is directed to a multimedia playing method and system for moving vehicle, which are adapted to automatically play multimedia content related to environmental information nearby the moving vehicle, such that a passenger of the moving vehicle may deeply recall related good memories through the played multimedia content.

The invention provides a multimedia playing method for a moving vehicle, which includes following steps. At least one multimedia content is stored in a multimedia database. A search condition is obtained according to environmental information nearby the moving vehicle. The multimedia database is queried according to the search condition to retrieve at least one target multimedia content matching to the search condition. The target multimedia content is played by a multimedia playing device on the moving vehicle.

According to another aspect, the invention provides a multimedia playing system for a moving vehicle. The multimedia playing system includes an information input device, a multimedia playing device, a memory, and a processor. The information input device obtains environmental information nearby the moving vehicle. The memory records a plurality of instructions, and the processor is coupled to the information input device, the multimedia playing device and the memory, and is configured to execute the instructions to execute following steps. A search condition is obtained according to the environmental information nearby the moving vehicle.

The multimedia database is queried according to the search condition to retrieve at least one target multimedia content matching to the search condition. The target multimedia content is played by the multimedia playing device on the moving vehicle.

According to the above description, in the multimedia playing method and system for moving vehicle of the invention, the search condition is determined according to the environmental information nearby the moving vehicle, and the target multimedia content related to the current environment is selected from the multimedia database to play according to the search condition. In this way, along with movement of the moving vehicle, the multimedia playing device plays a specific multimedia content along with variation of the environment, such that a passenger or a rider of the moving vehicle may recall the good memories through the played multimedia content on the journey.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a multimedia playing system for moving vehicle according to an embodiment of the invention.

FIG. 2 is a flowchart illustrating a multimedia playing method for moving vehicle according to an embodiment of the invention.

FIG. 3 is a flowchart illustrating a multimedia playing method for moving vehicle according to an embodiment of the invention.

FIG. 4 is a schematic diagram of playing multimedia content according to an embodiment of the invention.

FIG. 5 is a flowchart illustrating a multimedia playing method for moving vehicle according to an embodiment of the invention.

FIG. 6 is a flowchart illustrating a multimedia playing method for moving vehicle according to an embodiment of the invention.

FIG. 7 is a schematic diagram of playing multimedia content according to an embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts. Theses exemplary embodiments are only a part of the disclosure, and the disclosure does not disclose all of the implementations. More precisely, these exemplary embodiments are only examples of the system and method in the claims of the disclosure.

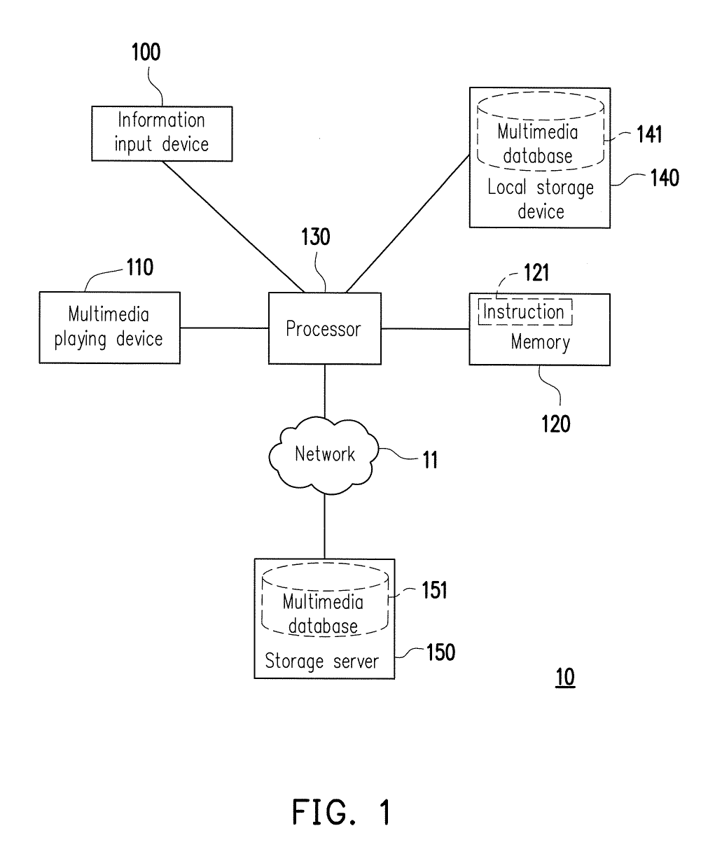

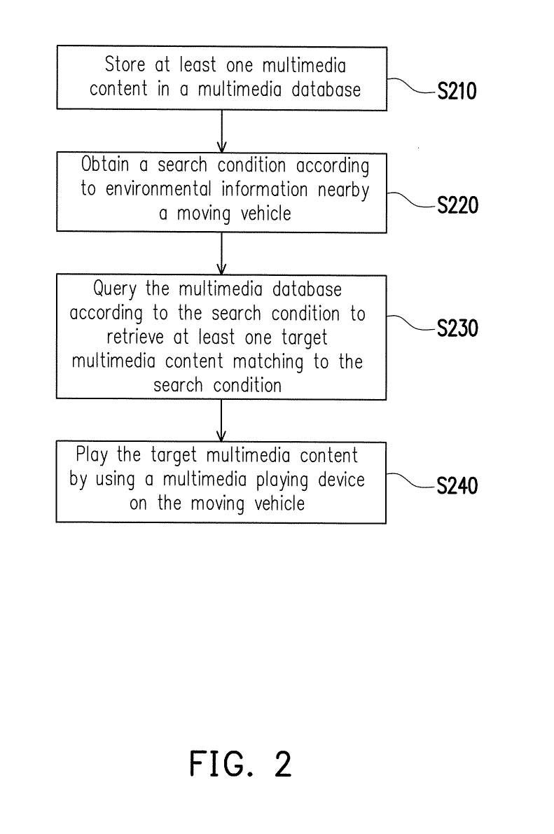

FIG. 1 is a block diagram of a multimedia playing system for moving vehicle according to an embodiment of the invention, which is only an example, and the invention is not limited thereto. Components and configuration relationship of the components of the electronic apparatus of FIG. 1 are first introduced, and detailed functions thereof are disclosed with reference of FIG. 2.

Referring to FIG. 1, the multimedia playing system 10 is adapted to be configured on a moving vehicle, and includes an information input device 100, a multimedia playing device 110, a memory 120, and a processor 130. The moving vehicle refers to a general dynamic vehicle, for example, a scooter, a motorcycle, a locomotive, a car, a boat, a plane, etc.

The memory 120 is, for example, any type of a fixed or movable random access memory (RAM), read-only memory (ROM), flash memory, hard disk or other similar devices or a combination of the above devices, which is used for storing file data. Moreover, the memory 120 is further used for recording a plurality of instructions 121 that can be executed by the processor 140.

The processor 130 is, for example, a central processing unit (CPU), or other programmable general purpose or special purpose microprocessor, a digital signal processor (DSP), a programmable controller, application specific integrated circuits (ASIC), a programmable logic device (PLD) or other similar devices or a combination of the above devices. The processor 130 is coupled to the information input device 100, the multimedia playing device 110 and the memory 120, and is configured for accessing the instructions in the memory 120 to execute a multimedia playing function.

The information input device 100 is used for obtaining environmental information nearby the moving vehicle, and may have an image capturing function, a recording function, an environment sensing function, a positioning function or a combination thereof. The information input device 100 may be an electronic device such as a smart phone, a smart watch, a smart bracelet, a tablet personal computer, a driving recorder, a navigator, etc., or may be an image capturing device, a recording device, a temperature sensor, a humidity sensor, etc., that has a single function, which is not limited by the invention.

The multimedia playing device 110 has the multimedia playing function, and is, for example, any type of a display device, a loudspeaker, an earphone or a combination thereof. When the user rides the moving vehicle, the user may view or listen to a multimedia content through the multimedia playing device 110 of the present embodiment. For example, the multimedia playing device 110 can be an electronic dashboard on a car or a scooter; the multimedia playing device 110 can also be a loudspeaker set in a helmet, or the multimedia playing device 110 can also be a screen or a speaker of a smart phone of a rider or a passenger, which is not limited by the invention.

Moreover, the multimedia playing system 10 further includes a local storage device 140 or a storage server 150. The local storage device 140 stores a multimedia database 141, and the storage server 150 may also store a multimedia database 151. The processor 120 can be connected to the local storage device 140 through a data transmission interface (such as a USB interface, a PCIE interface, etc.) to access the multimedia content in the multimedia database 141. Alternatively, the processor 120 can be connected to the storage server 150 through a network 11 by using a communication circuit, so as to access the multimedia content in the multimedia database 151.

FIG. 2 is a flowchart illustrating a multimedia playing method for moving vehicle according to an embodiment of the invention. Referring to FIG. 2, the method of the present embodiment is adapted to the multimedia playing system 10 of FIG. 1, and detailed steps of the multimedia playing method for moving vehicle of the invention are described below with reference of various components of the multimedia playing system 10.

First, in step S210, the local storage device 140 or the storage server 150 stores at least one multimedia content in the multimedia database 141 or the multimedia database 151. The multimedia content can be an image, a movie, an audio or a combination thereof. For example, the multimedia contents can be photos, video clips photographed by the user, or recording files produced by the user, which is not limited by the invention.

In step S220, the processor 130 obtains a search condition according to the environmental information nearby the moving vehicle. In detail, the processor 130 obtains the environmental information nearby the moving vehicle through the information input device 100, and the environmental information can be an image nearby the moving vehicle, a sound nearby the moving vehicle, a sensing temperature of the environment where the moving vehicle is located, a sensing humidity of the environment where the moving vehicle is located, or positioning information of the moving vehicle, etc. Moreover, the environmental information can also be an environmental characteristic obtained by further recognizing the aforementioned image or sound. According to the above description, after the processor 130 obtains the environmental information nearby the moving vehicle through the information input device 100, the processor 130 may determine the search condition according to the above environmental information. The search condition includes at least one indexer, and the indexers respectively correspond to specific environmental information. The indexer is, for example, implemented in form of a keyword, a code, a digit, etc., which is not limited by the invention.

Then, in step S230, the processor 130 queries the multimedia database 141 or the multimedia database 151 according to the search condition to retrieve at least one target multimedia content matching to the search condition. The processor 130 may compare the search condition with description files of the multimedia contents or compare the search condition with pre-created tags to implement file searching. In this way, the multimedia content related to the environmental information nearby the moving vehicle can be selected from the multimedia database 141 or the multimedia database 151.

To be specific, in an embodiment, when the multimedia content is stored to the multimedia database 141 or the multimedia database 151, a tag corresponding to the multimedia content is simultaneously created and recorded to the multimedia database 141 or the multimedia database 151 at the same time. The tag can be used for describing a content characteristic, a shooting time, a shooting place, etc. of the multimedia content. The tag is, for example, implemented in form of a keyword, a code, a digit, etc., which is not limited by the invention. Therefore, the processor 130 may select at least one target multimedia content matching to the search condition by comparing the indexer of the search condition with the tags of the multimedia contents.

In an embodiment, when the multimedia contents are stored to the multimedia database 141 or the multimedia database 151, the description files of the multimedia contents are also recorded to the multimedia database 141 or the multimedia database 151 at the same time. The description file is used for recording description information of the multimedia content, for example, metadata of the multimedia content or an exchangeable image file (EXIF), etc. For example, the description information may include a shooting time, a shooting place, a media creation date, or a media type, etc. Therefore, the processor 130 may compare the indexer of the search condition with the description files of the multimedia contents to find the at least one target multimedia content matching to the search condition.

Then, in step S240, the processor 130 plays the target multimedia content by using the multimedia playing device 110 on the moving vehicle. In detail, after the processor 130 queries the multimedia database 141 or the multimedia database 151 according to the search condition to generate a search result, the processor 130 may drive the multimedia playing device 110 on the moving vehicle to play the at least one target multimedia content according to the search result. Namely, the number of the target multimedia contents matching to the search condition can be greater than one.

For example, when the processor 130 selects three images according to the search condition, the processor 130 may drive the electronic dashboard of the moving vehicle to sequentially display the three images. When the processor 130 selects one image and one audio file according to the search condition, the processor 130 may drive the electronic dashboard of the moving vehicle to display the selected image and meanwhile drive the loudspeaker in the helmet to play the selected audio file. When the processor 130 selects a video clip according to the search condition, the processor 130 may drive the smart phone of the rider of the moving vehicle to play the selected video clip.

An embodiment is provided below to describe how to obtain the search condition according to the environmental information.

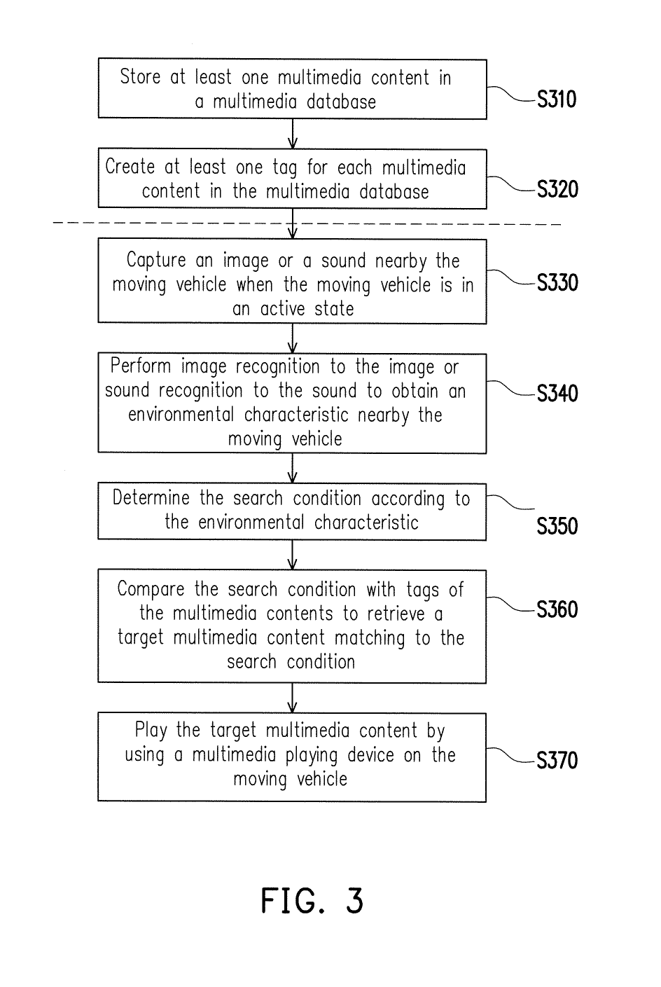

FIG. 3 is a flowchart illustrating a multimedia playing method for moving vehicle according to an embodiment of the invention. Referring to FIG. 3, the method of the present embodiment is adapted to the multimedia playing system 10 of FIG. 1, and detailed steps of the multimedia playing method for moving vehicle of the invention are described below with reference of various components of the multimedia playing system 10. It should be noted that the information input device 100 is, for example, an image capturing device or a recording device, though the invention is not limited thereto.

In step S310, the local storage device 140 stores at least one multimedia content to the multimedia database 141. In step S320, the local storage device 140 creates at least one tag for each multimedia content in the multimedia database 141, where the tag can be created according to a presented characteristic, a creation location, a creation date, etc. of the multimedia content. The steps S310 and 5320 are used for creating the multimedia database 141.

In step S330, when the moving vehicle is in an active state, the processor 130 captures images or sounds nearby the moving vehicle by using the image capturing device or the recording device. For example, the processor 130 may capture images or sounds nearby the moving vehicle through a driving recorder. Alternatively, the processor 130 may also capture images or sounds nearby the moving vehicle by using a smart phone or a smart wearable device of the rider of the moving vehicle.

Then, in step S340, the processor 130 performs image recognition to the image or sound recognition to the sound to obtain an environmental characteristic nearby the moving vehicle. In detail, through the sound recognition and the image recognition, the processor 130 may capture the environmental characteristic from the sound and image nearby the moving vehicle, where the environmental characteristic may include a scenery type, a building type, a neighboring object or a combination thereof. For example, when the image captured by the information input device 100 includes a mountain scenery, the processor 130 confirms that the environmental characteristic nearby the moving vehicle includes a scenery type recognized as “mountain”. When the image captured by the information input device 100 includes a temple, the processor 130 confirms that the environmental characteristic nearby the moving vehicle includes a building type recognized as “temple”. When the image captured by the information input device 100 includes a cow, the processor 130 confirms that the environmental characteristic nearby the moving vehicle includes a neighboring object recognized as “cow”.

In step S350, the processor 130 determines the search condition according to the environmental characteristic. Further, in the present embodiment, the processor 130 may establish an indexer of the search condition according to a recognition result of the environmental characteristic. For example, when the processor 130 confirms that the environmental characteristic nearby the moving vehicle includes the scenery type recognized as “mountain”, the processor 130 may take “mountain” as one of the indexers of the search condition. When the processor 130 confirms that the environmental characteristic nearby the moving vehicle includes the scenery type recognized as “mountain” and the building type recognized as “temple”, the processor 130 may take both of “mountain” and “temple” as the indexers of the search condition.

Then, after the search condition is determined, in step S360, the processor 130 compares the search condition with tags of the multimedia contents in the multimedia database 141 to retrieve a target multimedia content matching to the search condition. For example, when the processor 130 queries the multimedia database 141 according to the indexer “mountain” of the search condition, the processor 130 may select a target image, and the tag of the target image is indicated as “mountain”. In step S370, the processor 130 plays the target multimedia content through the multimedia playing device 110 on the moving vehicle. In this way, the passenger or rider of the moving vehicle may view photos, video clips or recording files related to the surrounding environment on the journey, so as to deeply experience the past good memories.

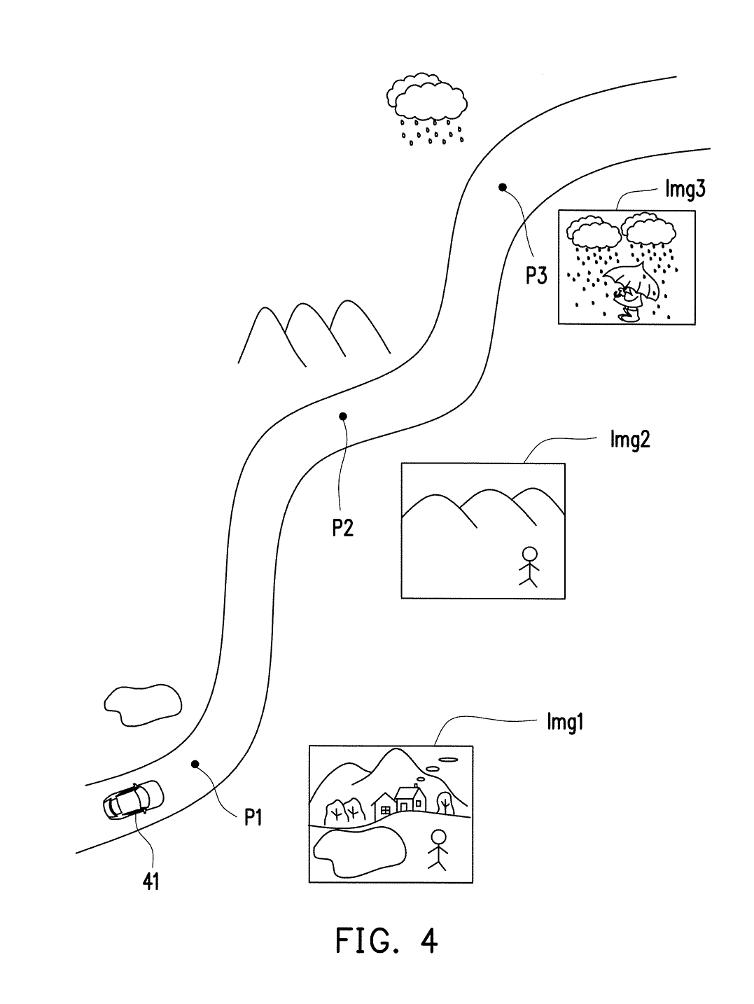

FIG. 4 is a schematic diagram of playing the multimedia content according to an embodiment of the invention. Referring to FIG. 4, it is assumed that the multimedia playing system 10 of the invention is disposed on the moving vehicle 41, and the moving vehicle 41 moves along a path to sequentially pass through positions P1-P3. When the moving vehicle 41 reaches the position P1, the image capturing device on the moving vehicle 41 may capture an image with a lake scenery, and the processor 130 accordingly confirms that the environmental characteristic nearby the moving vehicle 41 includes a scenery type recognized as “lake”, and takes “lake” as one of the indexers of the search condition to query the multimedia database 141. Then, the processor 130 may drive the multimedia playing device 110 to display an image Img1, where the image Img1 is an image captured by the lake by the passenger of the moving vehicle 41.

Then, when the moving vehicle 41 continually moves to the position P2, the image capturing device on the moving vehicle 41 may capture an image with a mountain scenery, and the processor 130 accordingly confirms that the environmental characteristic nearby the moving vehicle 41 includes the scenery type recognized as “mountain”, and takes “mountain” as one of the indexers of the search condition to query the multimedia database 141. Then, the processor 130 may drive the multimedia playing device 110 to display an image Img2, where the image Img2 is an image captured on the mountain by the passenger of the moving vehicle 41.

Then, when the moving vehicle 41 continually moves to the position P3, an image captured by the image capturing device on the moving vehicle 41 does not include a specific geographic scenery, though the image captured at the position P3 includes a rain scenery. The processor 130 accordingly confirms that the environmental characteristic nearby the moving vehicle 41 includes the scenery type recognized as “rain”, and takes “rain” as one of the indexers of the search condition to query the multimedia database 141. Then, the processor 130 may drive the multimedia playing device 110 to display an image Img3, where the image Img3 is an image captured in the rain by the passenger of the moving vehicle 41.

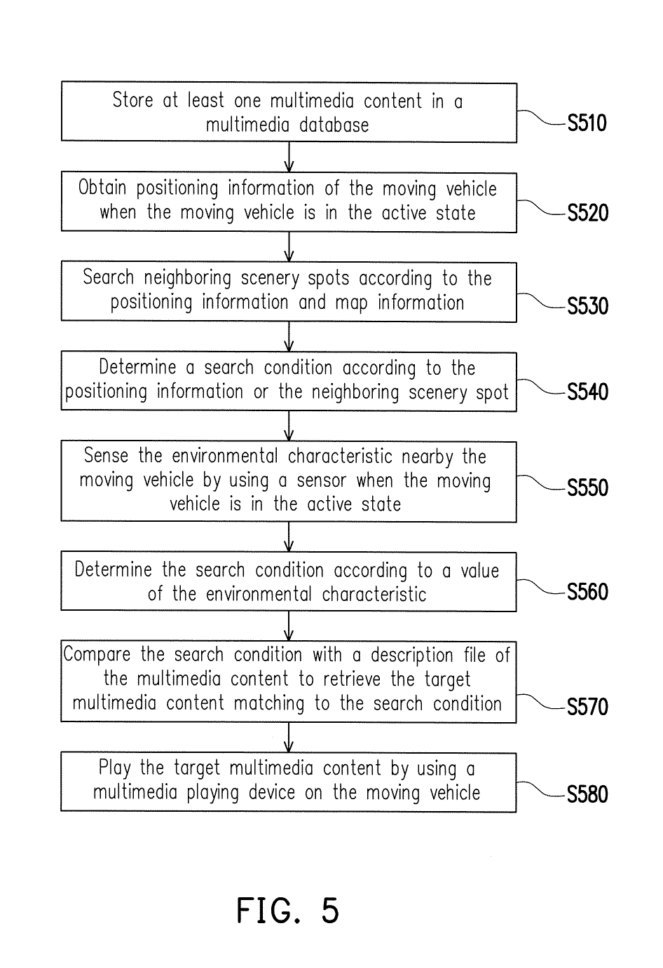

FIG. 5 is a flowchart illustrating a multimedia playing method for moving vehicle according to another embodiment of the invention. Referring to FIG. 5, the method of the present embodiment is adapted to the multimedia playing system 10 of FIG. 1, and detailed steps of the multimedia playing method for moving vehicle of the invention are described below with reference of various components of the multimedia playing system 10. It should be noted that the information input device 100 is, for example, a sensor or a positioning device, though the invention is not limited thereto.

In step S510, the storage server 150 stores at least one multimedia content to the multimedia database 151. In step S520, when the moving vehicle is in the active state, the processor 130 obtains positioning information of the moving vehicle through the positioning device. The positioning information can be positioning coordinates of the moving vehicle, or the positioning information is taken as a reference area. In step S530, the processor 130 searches neighboring scenery spots according to the positioning information and map information. For example, the processor may obtain the positioning coordinates of the moving vehicle through a GPS positioning device, and searches neighboring scenery spots according to the positioning coordinates in the map information provided by a map application. The above neighboring scenery spots are, for example, a restaurant, an amusement park, a park, a memorial hall, a shopping center, a bathing beach, etc., which are not limited by the invention.

In step S540, the processor 130 determines a search condition according to the positioning information or the neighboring scenery spot. In detail, the processor 130 may directly take the GPS positioning coordinates as the search condition or take the searched neighboring scenery spot as the search condition. The processor 130 may take the positioning information or the neighboring scenery spot as the indexers of the search condition. If the neighboring scenery spot is taken as one of the indexers of the search condition, the processor 130 may retrieve the multimedia content related to the neighboring scenery spot. If the positioning coordinates are taken as one of the indexers of the search condition, the processor 130 may retrieve the multimedia content captured within an area nearby the aforementioned positioning coordinates.

In the present embodiment, besides that the search condition can be determined according to the positioning information, the search condition can also be determined according to an environmental characteristic sensed by a sensor. In step S550, when the moving vehicle is in the active state, the processor 130 senses the environmental characteristic nearby the moving vehicle by using the sensor, where the environmental characteristic may include a sensing temperature, a sensing humidity, a sensing height or a combination thereof. In other words, the sensor can be a temperature sensor, a humidity sensor, a height sensor, etc., and the sensor may detect the environmental characteristic nearby the moving vehicle. Then, in step S560, the processor 130 determines the search condition according to a value of the environmental characteristic. The processor 130 may determine the indexer of the search condition according to the value of the environmental characteristic through a table look-up method. For example, when the sensing temperature is greater than a threshold, the processor 130 may determine to take “August” or “summer” as one of the indexers of the search condition. When the sensing height is greater than a threshold, the processor 130 may determine to take “mountain” as one of the indexers of the search condition.

Then, in step S570, the processor 130 compares the search condition with a description file of the multimedia content in the multimedia database 151 to retrieve the target multimedia content matching to the search condition. In step S580, the processor 130 plays the target multimedia content through the multimedia playing device on the moving vehicle. In this way, the passenger or rider of the moving vehicle may view photos, video clips or recording files related to the surrounding environment on the journey, so as to deeply experience the past good memories.

However, the implementation of the invention is not limited to the above description, and the content of the aforementioned embodiment can be properly varied according to an actual demand. For example, in an embodiment of the invention, the multimedia playing system may retrieve a specific multimedia content to play according to a current time. An embodiment is provided below for further description.

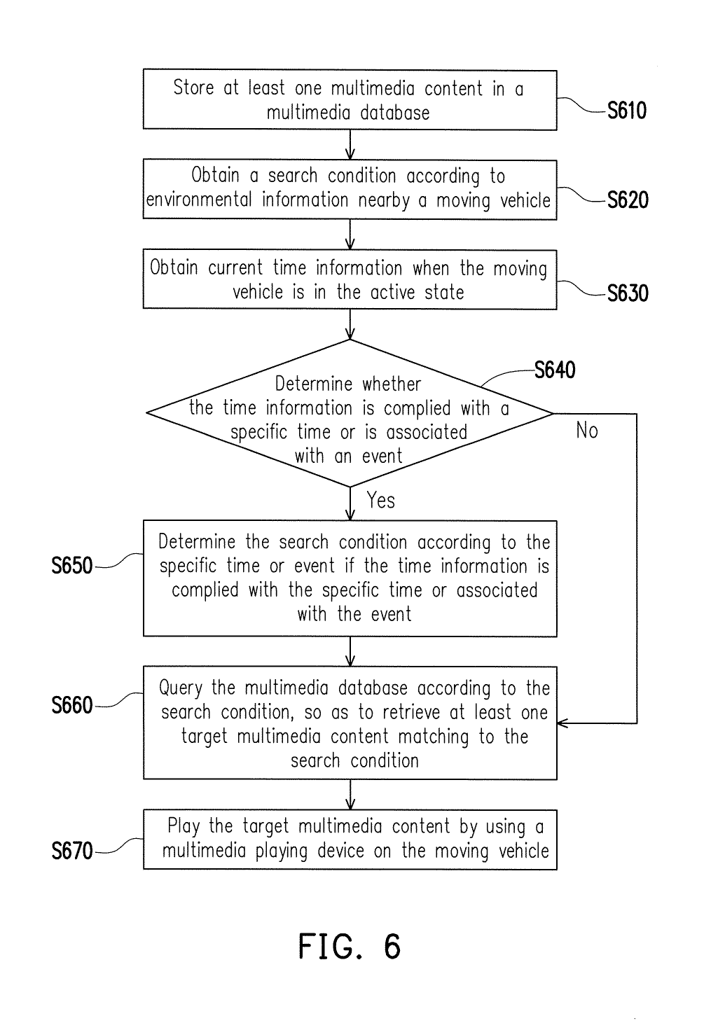

FIG. 6 is a flowchart illustrating a multimedia playing method for moving vehicle according to another embodiment of the invention. Referring to FIG. 6, the method of the present embodiment is adapted to the multimedia playing system 10 of FIG. 1, and detailed steps of the multimedia playing method for moving vehicle of the invention are described below with reference of various components of the multimedia playing system 10.

In step S610, the local storage device 140 stores at least one multimedia content to the multimedia database 141. In step S620, the processor 130 obtains a search condition according to environmental information nearby the moving vehicle. The way of obtaining the search condition according to the environmental information has been described in detail in the aforementioned embodiment, and detail thereof is not repeated. Then, in step S630, when the moving vehicle is in the active state, the processor 130 obtains current time information. In step S640, the processor 130 determines whether the time information is complied with a specific time or is associated with an event. In detail, the processor 130 may determine whether the current time is a specific festival, and the processor 130 may also determine whether the current time is associated with a specific event marked by the user through a calendar application.

Then, in step S650, if the time information is complied with the specific time or associated with the event, the processor 130 determines the search condition according to the specific time or event. To be specific, the processor 130 may directly take the specific time or the festival corresponding to the specific time as one of the indexers of the search condition. Alternatively, if the current time is associated with an event, the processor 130 may directly take the event as one of the indexers of the search condition. The event is, for example, a year-end part, a birthday party, a dinner party, etc. If the determination result of the step S640 is negative, the processor 130 does not determine the search condition according to the specific time or event, and a step S660 is executed.

After the search condition is determined according to the environmental characteristic sensed by the sensor and the current time, in step S660, the processor 130 queries the multimedia database 141 according to the search condition, so as to retrieve at least one target multimedia content matching to the search condition. In step S670, the processor 130 plays the target multimedia content through the multimedia playing device 110 on the moving vehicle. In this way, the passenger or rider of the moving vehicle may view photos, video clips or recording files related to the surrounding environment and the current time point on the journey, so as to deeply experience the past good memories.

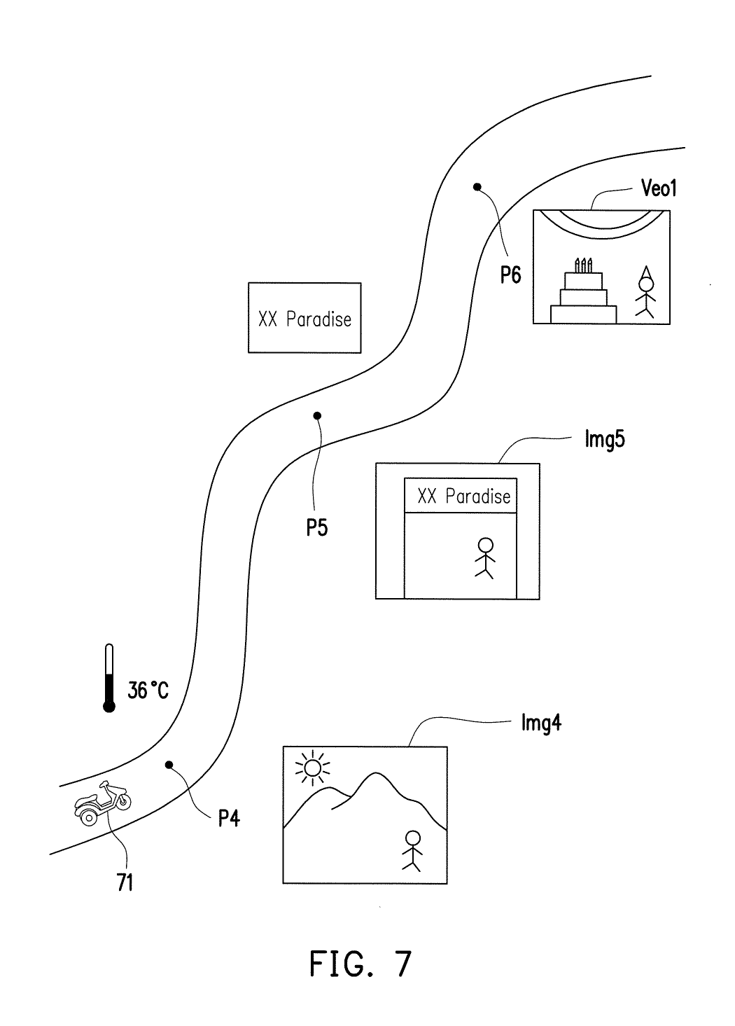

FIG. 7 is a schematic diagram of playing the multimedia content according to an embodiment of the invention. Referring to FIG. 7, it is assumed that the multimedia playing system 10 of the invention is disposed on the moving vehicle 71, and the moving vehicle 71 moves along a path to sequentially pass through positions P4-P6. When the moving vehicle 71 reaches the position P4, the temperature sensor on the moving vehicle 71 detects that the sensing temperature is 36 degrees Celsius, and the processor 130 confirms that the sensing temperature is higher than a threshold, and accordingly takes “summer” or “August” as one of the indexers of the search condition to query the multimedia database 141. Then, the processor 130 may drive the multimedia playing device 110 to display an image Img4, where the image Img4 is an image captured in summer by the passenger of the moving vehicle 71.

Then, when the moving vehicle 71 reaches the position P5, the positioning device on the moving vehicle 71 obtains positioning coordinates corresponding to the position P5, and searches a neighboring scenery spot “XX Paradise” according to the positioning coordinates. In this way, the processor 130 may directly take “XX paradise” as one of the indexers of the search condition to query the multimedia database 141. Then, the processor 130 may drive the multimedia playing device 110 to display an image Img5, where the image Img5 is an image captured at the neighboring scenery spot by the passenger of the moving vehicle 71.

Then, when the moving vehicle 71 reaches the position P6, the processor 130 cannot obtain the search condition related to the environmental characteristic or the positioning information, though the processor 130 may determine that the current time is related to an event “birthday”, and takes “birthday” as one of the indexers of the search condition to query the multimedia database 141. Then, the processor 130 may drive the multimedia playing device 110 to display a video clip Veo1, where the video clip Veo1 is a video clip recorded by the passenger of the moving vehicle 71 in birthday celebration of a friend.

In summary, in the embodiments of the invention, the multimedia playing system for moving vehicle may retrieve the multimedia content related to the environmental information nearby the moving vehicle, and play the same by using the multimedia playing device on the moving vehicle. In this way, during a moving process of the moving vehicle, the passenger of the moving vehicle may view or listen to the multimedia content selected according to the environmental information to deeply feel the situation and experience when the multimedia content is recorded, so as to recall the happy memories. Therefore, existing value of the multimedia content is further increased. Moreover, the multimedia playing system for moving vehicle of the invention may not only improve user's experience, but may also have an effect of keeping people's pleasant mood.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A multimedia playing method for a moving vehicle, comprising:
storing at least one multimedia content in a multimedia database;
obtaining a search condition according to environmental information nearby the moving vehicle;
querying the multimedia database according to the search condition to retrieve at least one target multimedia content matching to the search condition; and
playing the target multimedia content through a multimedia playing device on the moving vehicle.

2. The multimedia playing method for the moving vehicle as claimed in claim 1, wherein the step of obtaining the search condition according to the environmental information nearby the moving vehicle comprises:
sensing an environmental characteristic nearby the moving vehicle by using a sensor when the moving vehicle is in an active state; and
determining the search condition according to a value of the environmental characteristic.

3. The multimedia playing method for the moving vehicle as claimed in claim 2, wherein the environmental characteristic comprises a sensing temperature, a sensing humidity, a sensing height or a combination thereof.

4. The multimedia playing method for the moving vehicle as claimed in claim 1, wherein the step of obtaining the search condition according to the environmental information nearby the moving vehicle comprises:
capturing an image or a sound nearby the moving vehicle when the moving vehicle is in an active state;
performing image recognition to the image or performing sound recognition to the sound to obtain an environmental characteristic nearby the moving vehicle; and
determining the search condition according to the environmental characteristic.

5. The multimedia playing method for the moving vehicle as claimed in claim 4, wherein the environmental characteristic comprises a scenery type, a building type, a neighboring object or a combination thereof.

6. The multimedia playing method for the moving vehicle as claimed in claim 1, wherein the step of obtaining the search condition according to the environmental information nearby the moving vehicle comprises:
obtaining positioning information of the moving vehicle when the moving vehicle is in an active state;
searching a neighboring scenery spot according to the positioning information and map information; and
determining the search condition according to the positioning information or the neighboring scenery spot.

7. The multimedia playing method for the moving vehicle as claimed in claim 1, further comprising:
obtaining current time information when the moving vehicle is in an active state;
determining whether the time information is complied with a specific time or associated with an event; and
determining the search condition according to the specific time or the event when the time information is complied with the specific time or associated with the event.

8. The multimedia playing method for the moving vehicle as claimed in claim 1, further comprising:
creating at least one tag for each of the multimedia contents in the multimedia database,
wherein the step of querying the multimedia database according to the search condition to retrieve the target multimedia content matching to the search condition comprises:
comparing the search condition with the tags of the multimedia contents, so as to retrieve the target multimedia content matching to the search condition.

9. The multimedia playing method for the moving vehicle as claimed in claim 1, wherein the step of querying the multimedia database according to the search condition to retrieve the target multimedia content matching to the search condition comprises:
comparing the search condition with description files of the multimedia contents, so as to retrieve the target multimedia content matching to the search condition.

10. A multimedia playing system for a moving vehicle, comprising:
an information input device, obtaining environmental information nearby the moving vehicle;
a multimedia playing device;
a memory, recording a plurality of instructions;
a processor, coupled to the information input device, the multimedia playing device and the memory, and configured to execute the instructions to execute following steps:
obtaining a search condition according to the environmental information nearby the moving vehicle;
querying a multimedia database according to the search condition to retrieve at least one target multimedia content matching to the search condition; and
playing the target multimedia content by the multimedia playing device on the moving vehicle.

11. The multimedia playing system for the moving vehicle as claimed in claim 10, wherein the multimedia playing system comprises a local storage device coupled to the processor, the multimedia database is recorded in the local storage device, and the multimedia database stores at least one multimedia content.

12. The multimedia playing system for the moving vehicle as claimed in claim 10, wherein the multimedia database is recorded in a storage server, the multimedia database stores at least one multimedia content, and the processor is connected to the storage server through a network to access the multimedia content.

13. The multimedia playing system for the moving vehicle as claimed in claim 10, wherein the information input device comprises a sensor, and when the moving vehicle is in an active state, the processor senses an environmental characteristic nearby the moving vehicle by using the sensor, and determines the search condition according to a value of the environmental characteristic.

14. The multimedia playing system for the moving vehicle as claimed in claim 13, wherein the environmental characteristic comprises a sensing temperature, a sensing humidity, a sensing height or a combination thereof.

15. The multimedia playing system for the moving vehicle as claimed in claim 10, wherein the information input device comprises an image capturing device or a recording device, and when the moving vehicle is in an active state, the processor captures an image or a sound nearby the moving vehicle by using the image capturing device or the recording device,
wherein the processor performs image recognition to the image or performs sound recognition to the sound to obtain an environmental characteristic nearby the moving vehicle, and the processor determines the search condition according to the environmental characteristic.

16. The multimedia playing system for the moving vehicle as claimed in claim 15, wherein the environmental characteristic comprises a scenery type, a building type, a neighboring object or a combination thereof.

17. The multimedia playing system for the moving vehicle as claimed in claim 10, wherein the information input device comprises a positioning device, and when the moving vehicle is in an active state, the processor obtains positioning information of the moving vehicle by using the positioning device,
wherein the processor searches a neighboring scenery spot according to the positioning information and map information, and determines the search condition according to the positioning information or the neighboring scenery spot.

18. The multimedia playing system for the moving vehicle as claimed in claim 10, wherein when the moving vehicle is in an active state, the processor obtains current time information,
wherein the processor determines whether the time information is complied with a specific time or associated with an event, and when the time information is complied with the specific time or associated with the event, the processor determines the search condition according to the specific time or the event.

19. The multimedia playing system for the moving vehicle as claimed in claim 10, wherein the multimedia database stores at least one multimedia content, and each of the multimedia contents has at least one corresponding tag, and the processor compares the search condition with the tags of the multimedia contents, so as to retrieve the target multimedia content matching to the search condition.

20. The multimedia playing system for the moving vehicle as claimed in claim 10, wherein the multimedia database stores at least one multimedia content, and the processor compares the search condition with description files of the multimedia contents, so as to retrieve the target multimedia content matching to the search condition.
